(19) United States
(12) Patent Application Publication
(10) Pub. No.: US 2008/0297026 A1
(43) Pub. Date: Dec. 4, 2008

(54) APPARATUS OF FIELD EMISSION LIGHT SOURCE

(75) Inventors: Chuan-Hsu Fu, Miaoli County (TW); Yun-Chiao Hsiao, Hsinchu County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INDUSTRIAL TECHNOLOGY RESEARCH INSTITUTE, Hsinchu (TW)

(21) Appl. No.: 11/964,713

(22) Filed: Dec. 27, 2007

(30) Foreign Application Priority Data
May 29, 2007 (TW) 96119084

(51) Int. Cl. H01J 1/62; H01J 7/18

(52) U.S. Cl. 313/495; 313/553

(57) ABSTRACT

An apparatus of the field emission light source having a luminous area and a non-luminous area includes a first plate, a second plate, cathode structures, gate structures, emission sources, an anode layer, a fluorescent layer, a getter, a retaining device and a sealant. The cathode structures are disposed in the luminous area and on the first plate. The emission sources are disposed on the cathode structures. The anode layer is disposed on the second plate. The fluorescent layer is disposed on the anode layer. The getter is disposed in the non-luminous area and on one of the first and the second plates. The retaining device is disposed between the luminous area and the non-luminous area. The sealant is sandwiched between the first plate and the second plate. When activating the getter, the retaining device can prevent metal ions gushed from the getter from entering the luminous area.

### CROSS-REFERENCE TO RELATED APPLICATION

This application claims the priority benefit of Taiwan application serial no. 96119084, filed on May 29, 2007. The entirety of the above-mentioned patent application is hereby incorporated by reference herein and made a part of this specification.

### BACKGROUND OF THE INVENTION

1. Field of the Invention

The present invention relates to an apparatus of a field emission light source.

2. Description of Related Art

The principle of light generation in a field emission display device lies in an electron attraction at a tip of materials in a vacuum environment due to a strong electrical field. These field-emitted electrons leaving a cathode plate are accelerated toward a positively charged anode plate and ultimately bombard with fluorescent powder disposed thereon to generate luminescence. The cathode plate is employed as a field electron emission source, and the anode plate is used as a light-emitting source. The luminescence occurs when the electrons emitted from the cathode plate bombard to a fluorescent layer on the anode plate.

According to the principle of light generation in the field emission display device, the vacuum environment is required. Thus, to satisfy said requirement, it is disclosed by U.S. Pat. No. 6,422,824 that a getter is disposed in such an apparatus of a field emission light source for maintaining a vacuum level within a device and for absorbing parts of gas molecules.

After the getter is used for a period of time, it demands an activation to resume the functions. When activating the getter, however, metal ions may be gushed from the getter. Given that the metal ions are gushed to a display region, areas splashed by the gushed metal ions in the display region may be damaged. Therefore, the field emission effect may be adversely affected when it is unlikely to prevent electrode structures used for emitting lights from being splashed due to unlikelihood of controlling the metal ions gushed from the getter. As such, a direction in which the metal ions are gushed from the getter is required to be precisely monitored.

### SUMMARY OF THE INVENTION

The present invention is related to an apparatus of a field emission light source. The apparatus is able to block metal ions gushed from a getter when activating the same, and better luminance of the apparatus of the field emission light source is further achieved.

The present invention provides an apparatus of a field emission light source having a luminous area and a non-luminous area. The apparatus includes a first plate, a second plate, a plurality of cathode structures, a plurality of gate structures, a plurality of emission sources, an anode layer, a fluorescent layer, a getter, a retaining device and a sealing member. The second plate is disposed opposite to the first plate. The plurality of the cathode structures is disposed in the luminous area and on a surface of the first plate, wherein the surface faces the second plate. The plurality of the emission sources is arranged on the cathode structures, respectively. The anode layer is disposed in the luminous area and on a surface of the second plate, wherein the surface faces the first plate. The fluorescent layer is disposed on the anode layer. The getter is disposed in the non-luminous area and on one of the first plate and the second plate. The retaining device is disposed between the luminous area and the non-luminous area. The sealant is sandwiched between the first plate and the second plate and seals the first plate and the second plate.

The apparatus of the field emission light source proposed by the present invention is equipped with the retaining device. As the getter is activated, the retaining device is able to block the metal ions gushed from the getter, and luminance of the apparatus of the field emission light source is further improved.

In order to the make the present invention comprehensible, several embodiments accompanied with figures are described in detail below. It is to be understood that both the foregoing general description and the following detailed description are exemplary, and are intended to provide further explanation of the invention as claimed.

### BRIEF DESCRIPTION OF THE DRAWINGS

FIG. 1 is a schematic cross-sectional view depicting an apparatus of a field emission light source according to one embodiment of the present invention.

FIG. 2 is a schematic cross-sectional view depicting an apparatus of a field emission light source according to another embodiment of the present invention.

FIG. 3 is a schematic cross-sectional view depicting an apparatus of a field emission light source according to still another embodiment of the present invention.

FIG. 4 is a schematic cross-sectional view depicting an apparatus of a field emission light source according to yet still another embodiment of the present invention.

### DESCRIPTION OF EMBODIMENTS

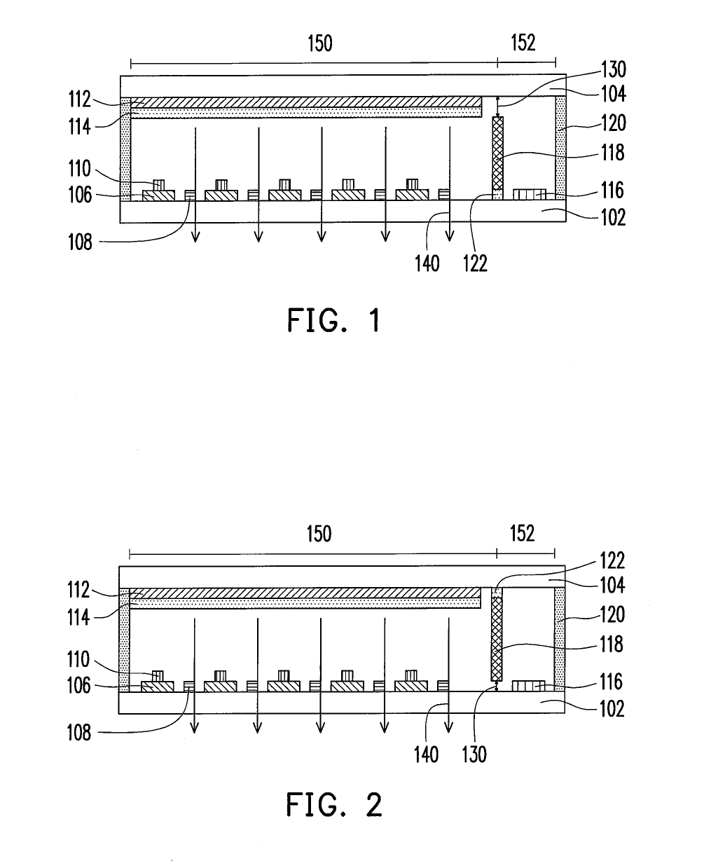

FIG. 1 is a schematic cross-sectional view depicting an apparatus of a field emission light source according to one embodiment of the present invention. The apparatus of the field emission light source has a luminous area 150 and a non-luminous area 152. The apparatus includes a first plate 102, a second plate 104, a plurality of cathode structures 106, a plurality of emission sources 110, an anode layer 112, a fluorescent layer 114, a getter 116, a retaining device 118 and a sealing member such as sealant 120 hereinafter. Besides, a plurality of gate structures 108 may also be disposed in the apparatus of the field emission light source if deemed necessary.

The second plate 104 is disposed opposite to the first plate 102. A material of the first plate 102 and the second plate 104 may be a transparent material including glass or any other non-transparent material.

The cathode structures 106 are disposed in the luminous area 150 and on a surface of the first plate 102, wherein the surface faces the second plate 104. A material of the cathode structures 106 may be a conductive material, such as silver, any other appropriate metal, a non-metallic material, and so forth.

The gate structures 108 are disposed in the luminous area 150 and on the surface of the first plate 102, wherein the surface faces the second plate 104. Each of the gate structures 108 is positioned adjacent to one of the cathode structures 106, respectively. A material of the gate structures 108 may be the conductive material, such as silver, any other appropriate metal, the non-metallic material, and so forth.

In one embodiment, a width between one of the cathode structures 106 and the adjacent gate structure 108 is substantially 700 micrometer, for example.

The emission sources 110 are disposed on the cathode structures 106, and the emission sources 110 are made of, for example, carbon nanotube (CNT) or other materials that are suitable for field electron emission. The CNT can be formed through arc evaporation, laser ablation of graphite, or chemical vapor deposition (CVD).

The anode layer 112 is disposed in the luminous area 150 and on a surface of the second plate 104, wherein the surface faces the first plate 102. The anode layer 112 may be a reflective structure and is made of silver, aluminum, or other appropriate materials, for example.

The fluorescent layer 114 is disposed on the anode layer 112. Particularly, the anode layer 112 and the fluorescent layer 114 are disposed between the second plate 104 and the first plate 102.

The getter 116 is disposed in the non-luminous area 152 and on the first plate 102. Besides, the getter 116 is utilized to maintain a vacuum level within a device and to absorb parts of gas molecules. The getter 116 may include a plurality of non evaporable getters, a plurality of evaporable getters, or a combination thereof. According to another embodiment of the present invention, the getter 116 may also be disposed on the second plate 104 (not shown).

The retaining device 118 is disposed between the luminous area 150 and the non-luminous area 152 without completely isolating the luminous area 150 from the non-luminous area 152. In other words, the luminous area 150 and the non-luminous area 152 are free from impediments disposed therebetween, and thus air diffuses to the non-luminous area 152 and is then absorbed by the getter 116, so as to maintain the vacuum level. When the getter 116 is activated, the retaining device 118 is adopted to prevent metal ions from gushing to the luminous area 150. A material of the retaining device 118 may be glass, ceramics or any other appropriate material.

The sealant 120 is sandwiched between the first plate 102 and the second plate 104 and seals the first plate 102 and the second plate 104, and the sealant 120 may be frit glue or other suitable materials. In addition, the sealant 120 can also provide the supporting function to keep the adequate gap between the first plate 102 and the second plate 104. Moreover, the support (not shown) can be placed or fabricated between the first plate 102 and the second plate 104 to maintain the adequate gap. The support may also be the sealant 120, for example, which is determined by actual designs and is not limited to the embodiments provided herein.

In one embodiment, the apparatus of the light source shown in FIG. 1 further includes a mounting device 122 for mounting the retaining device 118 to the first plate 102. Furthermore, the mounting device 122 may simply be a glue layer for securing the retaining device 118. In the present embodiment, a gap 130 exists between the retaining device 118 and the second plate 104 to keep the luminous area 150 and the non-luminous area 152 interlinked. However, the design of forming the gap 130 is not the only solution. For example, a hole formed in the retaining device 118 may serve as a replacement for the gap 130 to ensure that the two areas can be interlinked.

When the apparatus of the field emission light source is used as a backlight source for displays (not shown), the first plate 102 serves as a light emitting surface and is disposed towards a display panel (not shown), thus preventing a liquid crystal display panel from being affected by high heat generated on the second plate 104 and caused by the electrons bombarding to the fluorescent layer. When the apparatus of the field. emission light source is arranged as discussed above, the anode layer 112 is then composed of reflective materials. Moreover, since a reflective light 140 has to pass through the first plate 102, it is desired to use a transparent material to fabricate the first plate 102. However, when the apparatus of the field emission light source is not disposed in displays in the way as mentioned above, the anode layer 112 may be the reflective structure or a non-reflective structure. Furthermore, the first plate 102 and the second plate 104 may be made of the transparent material or a nontransparent material.

In one embodiment of the present invention, an aperture ratio of the apparatus of the field emission light source arranged in the way as mentioned above may reach 70% or more, for example.

FIG. 2 is a schematic cross-sectional view depicting an apparatus of a field emission light source according to another embodiment of the present invention. Since the structure and the function of the apparatus illustrated in FIG. 2 are similar to those depicted in FIG.1, the similarities and the dissimilarities therebetween will not be described hereinafter. By contrast, the difference lies in that the retaining device 118 is disposed on the second plate 104 in the apparatus of the field emission light source shown in FIG. 2. In the present embodiment, the gap 130 exists between the retaining device 118 and the first plate 102.

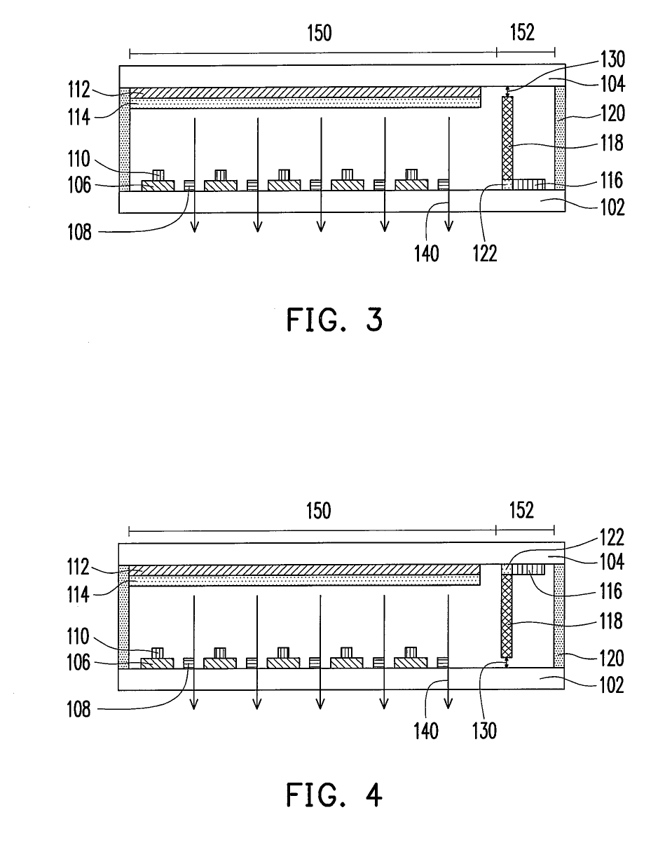

FIG. 3 is a schematic cross-sectional view depicting an apparatus of a field emission light source according to still another embodiment of the present invention. Since the structure and the function of the apparatus illustrated in FIG. 3 are similar to those depicted in FIG. 1, the similarities and the dissimilarities therebetween will not be described hereinafter. By contrast, the difference lies in that the retaining device 118 and the getter 116 are integrally formed. In particular, the retaining device 118 and the getter 116 are simultaneously manufactured, such that they are integrally structured. Further, the integral structure of the retaining device 118 and the getter 1 16 are made of the same metallic material, for example, and a disposition structure is incorporated in the integrated retaining device 118 and the getter 116. Here, the metallic material includes copper, aluminum, an alloy of metals, or any other similar material. The mounting device 122 is not required on said condition. In other words, the integral structure may be directly mounted between the two plates 102 and 104. The way of mounting the integral structure varies with actual demands. In the present embodiment, the integrally-formed retaining device 118 and the getter 116 are disposed on the first plate 102.

FIG. 4 is a schematic cross-sectional view depicting an apparatus of a field emission light source according to yet still another embodiment of the present invention. Since the structure and the function of the apparatus illustrated in FIG. 4 are similar to those depicted in FIG.3, the similarities and the dissimilarities therebetween will not be described hereinafter. By contrast, the difference lies in that the integrally-formed retaining device 118 and the getter 116 are disposed on the second plate 104 in the apparatus of the field emission light source shown in FIG. 4.

In light of the foregoing, the apparatus of the field emission light source proposed by the embodiments of the present invention is equipped with the retaining device that blocks the metal ions gushed from the getter when the getter is activated. Thereby, luminance efficiency of the apparatus of the field emission light source can be better achieved.

Additionally, the retaining device and the getter disclosed by another embodiment of the present invention are integrally formed. The integral structure is able to resolve an issue with respect to cracks occurring in a structurally-isolated retaining device due to stress.

According to an embodiment of the present invention, the retaining device and the getter are structurally isolated, for example.

According to an embodiment of the present invention, the retaining device may be, for example, disposed on one of the first plate and the second plate, whereas the getter is disposed on the other.

According to an embodiment of the present invention, the retaining device and the getter are both disposed on the first plate, for example.

According to an embodiment of the present invention, the retaining device and the getter are both disposed on the second plate, for example.

According to an embodiment of the present invention, the retaining device and the getter are integrally formed and disposed on the first plate, for example.

According to an embodiment of the present invention, the retaining device and the getter are integrally formed and disposed on the second plate, for example.

According to an embodiment of the present invention, the material of the retaining device is glass, ceramics or aluminum, for example.

According to an embodiment of the present invention, the getter includes a plurality of non evaporable getters, a plurality of evaporable getters, or a combination thereof, for example.

According to an embodiment of the present invention, the anode layer is a reflective structure, for example.

According to an embodiment of the present invention, the anode layer is a transparent structure, for example.

According to an embodiment of the present invention, the apparatus of the field emission light source further includes the mounting device for mounting the retaining device, for example.

According to an embodiment of the present invention, the gate structures may be further disposed in the luminous area and on the surface of the first plate, wherein the surface faces the second plate, for example. Each of the gate structures is positioned adjacent to one of the cathode structures, respectively.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An apparatus of a field emission light source, comprising:
a first plate having a luminous area and a non-luminous area;
a second plate disposed opposite to the first plate;
a plurality of cathode structures disposed in the luminous area and on a surface of the first plate, wherein the surface of the first plate faces the second plate;
a plurality of emission sources arranged on the cathode structures;
an anode layer disposed in the luminous area and on a surface of the second plate, wherein the surface of the second plate faces the first plate;
a fluorescent layer disposed on the anode layer;
a getter disposed in the non-luminous area and on one of the first plate and the second plate;
a retaining device disposed between the luminous area and the non-luminous area while the luminous area and the non-luminous area are still interlinked; and
a sealing member sandwiched between the first plate and the second plate and sealing the first plate and the second plate.

2. The apparatus of the field emission light source as claimed in claim 1, wherein the retaining device and the getter are structurally isolated.

3. The apparatus of the field emission light source as claimed in claim 2, wherein the retaining device is disposed on one of the first plate and the second plate, and the getter is disposed on the other.

4. The apparatus of the field emission light source as claimed in claim 2, wherein the retaining device and the getter are both disposed on the first plate.

5. The apparatus of the field emission light source as claimed in claim 2, wherein the retaining device and the getter are both disposed on the second plate.

6. The apparatus of the field emission light source as claimed in claim 1, wherein the retaining device and the getter are integrally formed and disposed on the first plate.

7. The apparatus of the field emission light source as claimed in claim 1, wherein the retaining device and the getter are integrally formed and disposed on the second plate.

8. The apparatus of the field emission light source as claimed in claim 1, wherein a disposition structure of the retaining device and the getter is an integrally-formed metallic structure.

9. The apparatus of the field emission light source as claimed in claim 1, wherein a material of the retaining device comprises glass, ceramics, or metal.

10. The apparatus of the field emission light source as claimed in claim 1, wherein the getter comprises a plurality of non evaporable getter, a plurality of evaporable getter, or a combination thereof.

11. The apparatus of the field emission light source as claimed in claim 1, wherein the anode layer is a reflective structure.

12. The apparatus of the field emission light source as claimed in claim 1, wherein the anode layer is a transparent structure.

13. The apparatus of the field emission light source as claimed in claim 1, further comprising a mounting device for mounting the retaining device.

14. The apparatus of the field emission light source as claimed in claim 1, further comprising a plurality of gate structures located in the luminous area, disposed on the surface of the first plate, wherein the surface of the first plate faces the second plate, and the gate structures are positioned adjacent to the cathode structures.
